(19) United States
(12) Patent Application Publication
(10) Pub. No.: US 2025/0217761 A1
(43) Pub. Date: Jul. 3, 2025

(54) UNIFIED MODEL FOR ACCURATE MULTI-OBJECT DETECTION

(71) Applicant: Walmart Apollo, LLC, Bentonville, AR (US)

(72) Inventors: Ashlin Ghosh, Kerala (IN); Paul Lobo, Mumbai (IN); Zhaoliang Duan, Frisco, TX (US); Raghava Balusu, Andhra Pradesh (IN); Avinash Madhusudanrao Jade, Bangalore (IN); Eric W. Rader, Plano, TX (US); Lingfeng Zhang, Flower Mound, TX (US); Mingquan Yuan, Flower Mound, TX (US); Siddhartha Chakraborty, West Bengal (IN); Han Zhang, Allen, TX (US); William Craig Robinson, Centerton, AR (US); Benjamin Ellison, San Francisco, CA (US); Ishan Arora, Bengalaru (IN); Yilun Chen, McKinney, TX (US); Ketan Shah, Bentonville, AR (US); Abhinav Pachauri, Kasavanahalli, Bangalore, Karnataka (IN); Rongdong Chai, Allen, TX (US)

(21) Appl. No.: 18/402,850

(22) Filed: Jan. 3, 2024

(51) Int. Cl. G06Q 10/087; G06V 10/764; G06V 20/60

(52) U.S. Cl. CPC G06Q 10/087; G06V 10/764; G06V 20/60; G06V 2201/07; G06V 2201/10

(57) ABSTRACT

Examples provide a multi-object detection model for identifying different types of objects of interest using input images of a selected area including a plurality of objects. A multi-object detection manager identifies instances of each object type by adding indicators for identifying the different types of objects, such as, but not limited to, pallets, pallet tags, horizontal bars, vertical bars, wooden bases on pallets, and empty spaces. The indicators are provided within an overlay superimposed on the image. The indicators include text-based labels and/or non-text based color-coded indicators, such as color-coded bounding boxes. In such cases, instances of a first type of object are identified using a first indicator and instances of a second type of object are identified using a different second indicator. The labeled image including the indicators is generated to enable users to determine the locations of objects within a retail environment with greater accuracy and efficiency.

### BACKGROUND

Computer vision object recognition can be used to analyze images of products and other objects within a store, warehouse, distribution center or other retail facility to automatically identify products, signs, location tags, shelving, and other objects using input images of the objects. However, an object detection model is typically only able to detect a single type of object. A different object detection model is required to detect each different type of object of interest. In order to detect and recognize two different types of objects, such as pallets and signage, two different object detection models are trained and maintained. Likewise, detecting three different types of objects of interest entails training and maintaining three individual object detection models. As the number of types of objects of interest increases, the number of individual models required to accurately identify those objects using image data also increases, hindering scalability. This is also inefficient, impractical, and potentially cost-prohibitive.

### SUMMARY

Some examples provide a system for multi-object detection with improved accuracy. The system includes an image capture device capturing an image of a plurality of objects of interest associated with a plurality of object types at a recognized location within a retail facility. The system analyzes one or more input images using a multi-object detection model to identify different types of objects of interest within the image. A multi-object detection manager identifies objects of interest of multiple different types, such as a first object of a first object type and a second object of a second object type. The multi-object detection manager generates a labeled image including indicators within an overlay associated with a selected image. The indicators include a first indicator for the first object of interest and a second indicator for the second object of interest within the selected image. The labeled image is presented to a user via a user interface device.

Other examples provide a system for multi-object detection with improved accuracy. An image capture device captures an image of a plurality of objects of interest associated with a plurality of object types at a recognized location within a retail facility. The multi-object detection manager analyzes the image using a multi-object detection model identifying the plurality of objects of interest within the image. The plurality of objects of interest associated with the plurality of object types are identified within the image. The plurality of objects of interest includes a first object associated with a first object type and a second object associated with a second object type. A labeled image is generated that includes a plurality of indicators within an overlay associated with the selected image.

Still other examples provide a computer storage devices having computer-executable instructions stored thereon, which, upon execution by a computer, cause the computer to perform operations comprising training a multi-object detection model using labeled training data that includes labeled objects of interest associated with the plurality of object types. An image is analyzed using a multi-object detection model identifying the plurality of objects of interest within the image. The objects of interest are identified in the image. Labeled image data is generated based on the image. The labeled image data includes class-specific indicators and/or object type indicators. The objects of interest are mapped to the recognized location based on the labeled image data. The objects are mapped to the recognized location in an item-to-location mapping table.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for multi-object detection.

FIG. 2 is an exemplary block diagram illustrating a system for uniform pallet layout detection using a unified object detection model.

FIG. 3 is an exemplary block diagram illustrating a multi-object detection model for detecting multiple types of objects using image data.

FIG. 4 is an exemplary block diagram illustrating a labeled image having an overlay labeling multiple different types of objects.

FIG. 5 is an exemplary block diagram illustrating an image overlay having labels associated with recognized objects in a plurality of different object types.

FIG. 6 is an exemplary flow chart illustrating operation of the computing device to detect multiple objects of a plurality of different object types.

FIG. 7 is an exemplary flow chart illustrating operation of the computing device to generate a labeled image including object type indicators for objects of interest.

FIG. 8 is an exemplary flow chart illustrating operation of the computing device to recognize objects of a plurality of different types

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

It is frequently desirable to automatically detect objects of interest within digital images of an area, such as, but not limited to, a reserve area, item display, storage area, and/or other area in a store, warehouse, or distribution center. Computer vision can be used to detect an object of interest from input images. However, a different model is typically required for each different type of object of interest. For example, a model trained to detect and recognize pallets would typically be unable to also recognize item storage structures, shopping carts, display case doors, etc. Other models are trained to recognize these other types of objects. Thus, to detect both pallets and steel bars in a given image would require two different object detection models separately trained to detect each different type of object. This is inefficient, cumbersome and resource intensive. Moreover, detecting pallets, pallet tags, pallet bins, void spaces, and other objects of interest in images using computer vision is frequently inaccurate and unreliable. This results in issues associated with accurately and efficiently identifying objects within a pallet reserve area.

Referring to the figures, examples of the disclosure enable a multi-object detection model. In some examples, the multi-object detection model is used to identify a plurality of objects of interest associated with a plurality of object types within one or more images of a selected area, such as a pallet reserve area, display cases, shelving, etc. An object can include any type of object, such as a product, pallet, signate, steel bar, etc. An object type is a classification or category in which a type of object fits, such as pallets, tags, vertical steel bars, horizontal steel bars, etc. The plurality of objects of interest includes two or more different objects associated with two or more different object types. This enables utilization of a single trained object detection model to detect and recognize multiple different types of objects. In this manner, the system trains and stores a single model in memory for multi-object recognition instead of training and storing two or more models in memory for reduced system memory and processor resource usage.

Some embodiments of the disclosure enable a trained deep learning convolutional neural network (CNN) model to analyze a plurality of images of a pallet reserve area and identify pallets, pallet wood, vertical bars, horizontal bars, void (empty) spaces and/or other objects of interest within images of the reserve area more accurately for use in inventory, locating items within the store, updating planograms, etc. The system reduces user time which would otherwise be spent manually searching for items in a retail facility and/or reduces errors in identifying the location of items within the reserve area enabling more accurate and efficient location of objects of interest.

Other embodiments provide a multi-object detection manager that generates a labeled image of a selected area by adding an overlay including labels and/or color-coded indicators to a selected image. Each type of indicator is associated with a different type of object. Thus, an image overlay having two or more different types of indicators associated with two or more different recognized objects of interest is provided. This image enables multi-object recognition by a single object recognition model with improved accuracy and reduced system resource usage. The recognized objects are mapped to the recognized location of the objects for improved accuracy identifying and locating objects within a retail space.

In other embodiments, the recognized and labeled objects of interest in a labeled image are presented to a user via a user interface (UI). The labeled image provides labeled objects of interest linked to a recognized location. This enables faster and more accurate identification and location of different types of objects of interest which increases user interaction performance and improves user efficiency via the UI.

Aspects of the disclosure further enable multi-object detection for uniform pallet layout recognition using a combined object detection model. The computing device operates in an unconventional manner by accurately detecting multiple different types of objects with a single object detection model. In this manner, the computing device is used in an unconventional way, and allows improved accuracy and efficiency in detecting multiple instances of different types of objects by a single, unified model which conserves memory and reduces processor load while further reducing item-to-location mapping errors, thereby improving functioning of the underlying computing device.

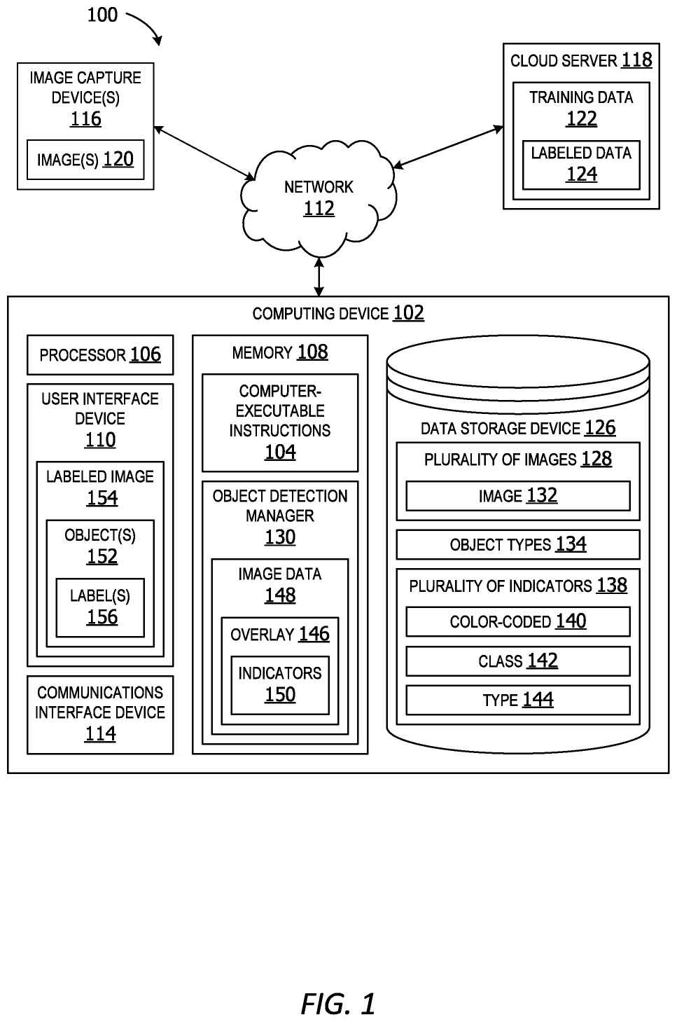

Referring again to FIG. 1, an exemplary block diagram illustrates a system 100 for multi-object detection. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

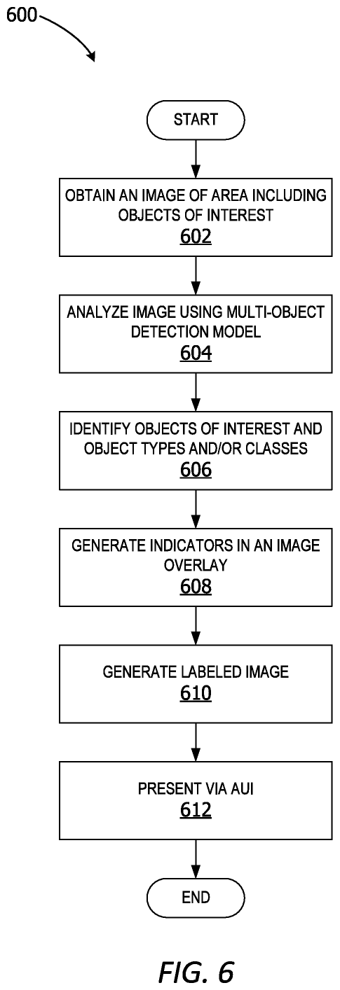

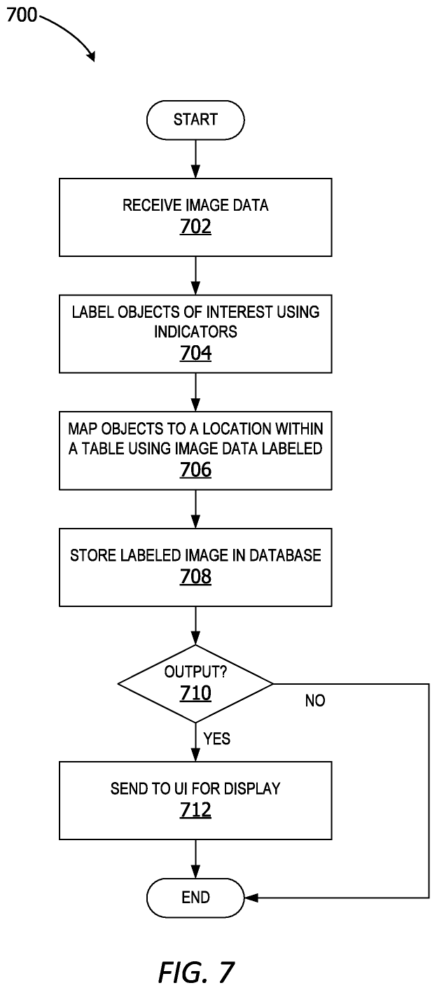

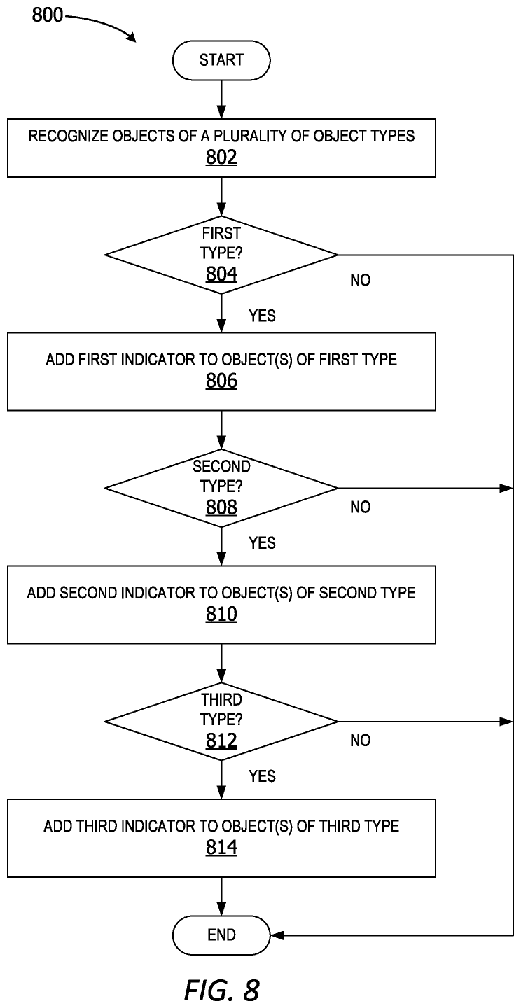

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, and FIG. 8).

The computing device 102 further has one or more computer-readable media such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to one or more image capture device(s) 116 and/or a cloud server 118, can occur using any protocol or mechanism over any wired or wireless connection. In some examples, the communications interface device 114 is operable with short range communication technologies such as by using near-field communication (NFC) tags.

The image capture device(s) 116 includes one or more devices for capturing image(s) 120 of multiple objects within an area of interest, such as, but not limited to, a pallet reserve area within a retail environment. The image capture device(s) 116, in this example, includes digital cameras capable of generating still images and/or moving video images of the area of interest. The image(s) 120 can include black-and-white (gray scale) images and/or color images. The image(s) 120 include images of objects, such as pallets, pallet tags, shelving, bins, and other objects of interest.

In these embodiments, the image(s) do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 120.

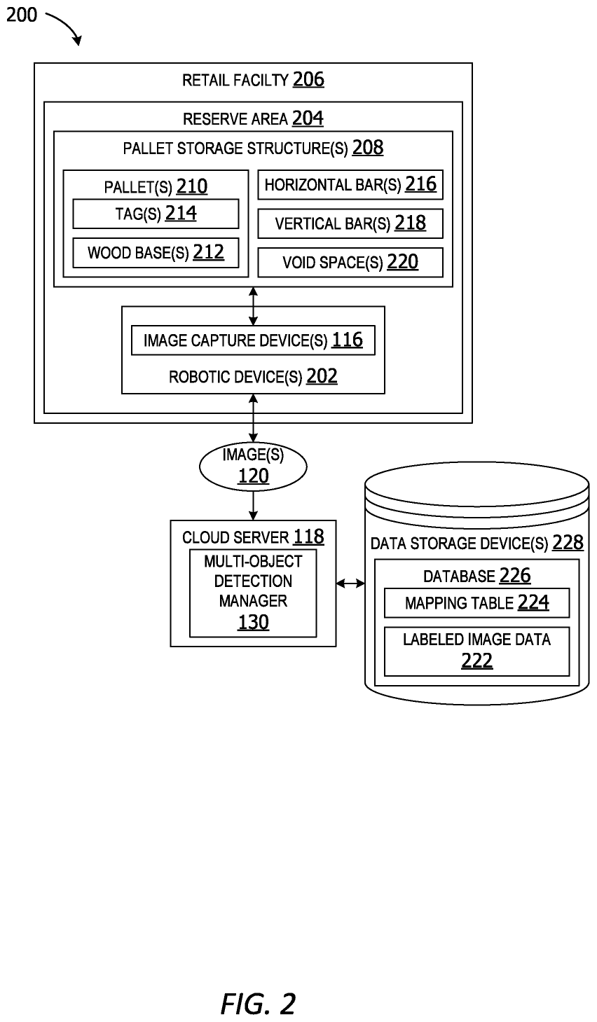

The image capture device(s) 116 optionally include camera(s) mounted on a robotic device, camera(s) incorporated within a user device, hand-held digital camera(s), and/or stationary camera(s) mounted on one or more fixtures within a retail environment, such as a store, distribution center, warehouse, or other facility. In some embodiments, an image capture device is mounted to a robotic device that roams around a retail facility, such as a store, taking pictures of pallets and other objects of interest within an area of interest, such as, but not limited to, a pallet storage area, as shown in FIG. 2 below.

The retail environment can include indoor spaces, outdoor spaces and/or spaces which are partially enclosed and partially unenclosed. The retail environment optionally includes retail stores, warehouses and/or distribution centers.

The pallet storage area is an area in which pallets are temporarily stored on shelves, bins, display cases, or other pallet storage structures. In some examples, pallets and/or individual items are stacked on the floor within the pallet storage area. The pallets and/or individual items can also be placed on an item storage structure, underneath an item storage structure, and/or adjacent to an item storage structure. An item storage structure can be a single unit or multiple units attached together via one or more fasteners. A unit includes a bin, display case, shelf unit, compartment, or any other unit associated with an item storage structure. An item storage structure can include multiple different shelves (levels) enabling some items/pallets to be placed at a higher level than other items/pallets. In this example, the pallet storage area is located on a sales floor of the retail facility which is inaccessible to customers. In other embodiments, the pallet storage area is located in a stock room, storage room, or other area which is not on the sales floor.

The cloud server 118 is a logical server providing services to the computing device 102 or other clients, such as user devices. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In this example, the cloud server 118 includes a cloud storage for storing data, such as, but not limited to, training data 122. The training data 122 is customized training data including labeled data 124. The labeled data 124 includes digital images of objects of interest associated with a plurality of different object types 134 of objects in multiple different object types and/or classes. The images include color images or black-and-white (gray scale) images. The multi-object detection manager 130 includes a multi-object detection model which is trained to detect instances of the plurality of different types of objects and label the objects based on the object types and/or the object classes for each detected object within one or more of the images.

Different types of objects are associated with different object classes. The different types of objects include, for example, but without limitation, pallet objects, pallet tag objects, pallet wooden base objects, pallet steel vertical bar objects, pallet steel horizontal bar objects, void (empty) spaces, and/or pallet partial-empty spaces. The different classes of objects include a pallet-related object class, location-related object class, and/or space-related object class. Pallets, pallet wooden bases and pallet tags are included in the pallet-related object class. Steel horizontal bars and steel vertical bars are in the location-related object class. The void (empty) spaces and partial-empty spaces are objects in the available space-related class.

The system 100 can optionally include a data storage device 126 for storing data, such as, but not limited to the plurality of image(s) 128 obtained from the one or more image capture device(s) 116, the plurality of object types 134, and/or a plurality of indicators 138. The plurality of indicators 138 includes one or more different indicators used to identify or otherwise label one or more instances of one or more different types of objects in an image 132. The indicators can include color-coded 140 indicators. A color-coded indicator is an indicator having a distinctive color associated with a given object type 144 or object class 142. For example, the indicator for pallet objects can include a red bounding box or red tag while the indicator for a horizontal steel bar is a blue bounding box and/or a blue tag. In this embodiment, each different type of object is identified in an image overlay 146.

The image overlay 146 is an overlay having a plurality of indicators 150 identifying each instance of an object of interest in image data 148. The indicators 150 optionally include a color-coded bounding box and/or a label/tag having text identifying the object type of each object of interest detected in the image 132.

The data storage device 126 can include one or more different types of data storage devices, such as, for example, one or more rotating disks drives, one or more solid state drives (SSDs), and/or any other type of data storage device. The data storage device 126 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 126 includes a database.

The data storage device 126, in the example shown in FIG. 1, is included within the computing device 102, attached to the computing device, plugged into the computing device, or otherwise associated with the computing device 102. In other embodiments, the data storage device 126 includes a remote data storage accessed by the computing device via the network 112, such as a remote data storage device, a data storage in a remote data center, or a cloud storage.

The memory 108, in some examples, stores one or more computer-executable components, such as, but not limited to, the multi-object detection manager 130. In some embodiments, the multi-object detection manager 130 obtains the image 132 of a recognized area associated with a retail facility. The image 132 includes multiple objects of interest associated with multiple different object types. For example, the image can include a pallet bin, two pallets on the pallet bin, a pallet tag on one of the pallets, and/or empty spaces on or near the bin which are available for storing additional pallets. The multi-object detection manager 130 analyzes the image 132 using a multi-object detection model that is trained on the training data 122. The multi-object detection model is trained to recognize the plurality of object types using image data 148 associated with the image 132.

The multi-object detection manager 130 identifies one or more object(s) 152 of interest associated with the plurality of object types within the image 132 and an object type 144 for each identified object. The multi-object detection manager 130 generates indicators 150 within the image data 148 associated with the object(s) 152. The indicators 150 include a different indicator for each different object type. The multi-object detection manager 130 generates a labeled image 154 of the recognized area. The labeled image 154 is the image 132 or a cropped portion of the image 132 with the overlay 146 superimposed over it. The labeled image includes the indicators 150 within the overlay 146.

In some embodiments, the labeled image 154 includes text indicators, such as label(s) 156 identifying the type of each instance of each object in the image. In some examples, the text included in the label(s) 156 are names or identifiers associated with each class or type of object, such as, but not limited to, a “pallet” label, a “tag” label, a “horizontal bar” label, a “vertical bar” label, a pallet “wood” base label, a “void” empty space label, etc. The labeled image 154 is stored in the data storage device 126, transmitted to the cloud server 118 and/or presented to the user via the user interface device 110.

Thus, the system can include non-text indicators 150 and/or text indicators, such as the label(s) 156. The indicators can include a name, abbreviation, alphanumeric code, identification number, or description of the object type.

In other embodiments, the indicators 150 are implemented as color-coded indicators, such as, different colored bounding boxes. A color-coded bounding box is any shape of bounding box, such as a color-coded rectangular bounding box placed around an object, a color-coded circle placed around an object, a color-coded triangle placed around an object, etc. In this example, different types of objects can be enclosed within a different shaped bounding box. The different shaped bounding boxes can include color-coding or no color-coding as the shape of each bounding box identifies the object class.

The indicators 150 can also optionally include a combination of color-coded non-text indicators as well as textual indicators, such as placing a color-coded bounding box around an object and adding a text label to further identify the object. However, the embodiments are not limited to textual indicators and color-coded bounding boxes. The indicators 150, in other embodiments, can include color-coded arrows pointing to objects of interest, color-coded lines placed under or above an object, highlighting/shading of objects in different colors to indicate different object types, or any other type of indicator which can be superimposed over an image of one or more objects.

The multi-object detection manager 130 in other embodiments, maps the object(s) 152 to the recognized location within an item-to-location mapping table. The table may be stored on the data storage device 126 and/or stored on the cloud server 118.

The system 100 provides a scalable, high performance object detection model that detects multiple different types of objects of interest and multiple instances of each type of object from an image with high accuracy. The model is a combined object detection model trained to detect two or more different types of objects and/or multiple instances of objects of interest in one or more images of an area, such as an image of a reserve area. The system 100 detects objects of interest from input images generated by one or more image capture devices, such as an autonomous robotic image capture device.

In this example, the multi-object detection manager 130 performs the functions of at least five different object detection models combined into one single, unified model (pallet and pallet tag; vertical steel bar; horizontal steel bar; pallet wood; and void). However, the embodiments are not limited to detecting five different types of objects. The multi-object detection manager 130 can be trained to detect any number of types of objects. In one example, the multi-object detection manager 130 can be trained to detect seven different types of objects. In other examples, the multi-object detection manager may be trained to detect four different types of objects, etc.

In this example, the input images are analyzed and labeled with bounding boxes for each object class/type using the labeling platform. The system detects objects such as, but not limited to, the pallet, pallet tag, pallet wood, vertical pallet steel bar, horizontal pallet steel bar and pallet void detection. In some examples, detected pallets and pallet tags are annotated with rectangles in the images. The wooden pallet base, vertical bar and horizontal bar on the pallet is annotated in the image(s) using polygon bounding boxes during image analysis. In this manner, the multi-object detection manager 130 detects objects, object classes and/or types of objects of interest in an image with improved accuracy.

In some embodiments, the labeled image results are output to an inventory management system for use in updating inventory data and/or pallet location data. The results can optionally also be used to create and/or update a planogram, restock shelves, update product order information, identify void spaces which are available for placement of pallets or other items. The multi-object detection manager can be trained to identify different types of objects using labeled training data.

Turning now to FIG. 2 is an exemplary block diagram illustrating a system 200 for uniform pallet layout detection using a unified object detection model is shown. In this example, the image capture device(s) 116 are mounted to one or more robotic device(s) 202 which roam around a reserve area 204 within a retail facility 206 generating image(s) 120. The retail facility 206 is a facility or area within a retail environment. The retail facility 206, in this example, is a store.

The image(s) 120 includes one or more images of one or more pallet storage structure(s) 208 and/or a portion of a pallet storage structure. A pallet storage structure is a structure for storing one or more pallet(s) 210. The pallet(s) 210 may be stored on the pallet storage structure, underneath the pallet storage structure, and/or adjacent to the pallet storage structure. The pallet storage structure includes pallet bins, shelving, display cabinets, end-cap displays, or any other pallet storage structures.

The pallet(s) 210 are associated with pallet wood base(s) 212 and/or pallet tag(s) 214 on the pallet(s) 210. A pallet tag, in this example, is a paper label affixed to an exterior surface of the pallet wrapping. The pallet tag includes information, such as, but not limited to, a pallet identification number, an item identification number associated with one or more item(s) in the pallet, a date the pallet tag was created, a barcode, and/or any other pallet-related information.

The pallet storage structure includes storage members, such as horizontal bar(s) 216 and/or vertical bar(s) 218. The horizontal and vertical bars in this example are made of steel. The pallet storage structure(s) 208 optionally includes void space(s) 220. A void space is an empty space or partially empty space on the storage structure, under the storage structure or adjacent to the storage structure in which another pallet could be placed.

In this example, the image(s) 120 are transmitted from the image capture device(s) to the cloud server 118 hosting the multi-object detection manager 130. The multi-object detection manager 130 analyzes the image(s) 120 to detect multiple instances of objects from multiple different object classes and/or different object types. The multi-object detection manager 130 generates labeled image data 222 including indicators identifying the type of each object identified in an image. The identified objects, in some embodiments, are mapped to the location of the pallet storage structure(s) 208 in a mapping table 224 stored on a database 226. The mapping table 224 and/or the labeled image data 222 are optionally stored on one or more data storage devices 228. The data storage device(s) 228 includes one or more devices for storing data, such as, the data storage device 126.

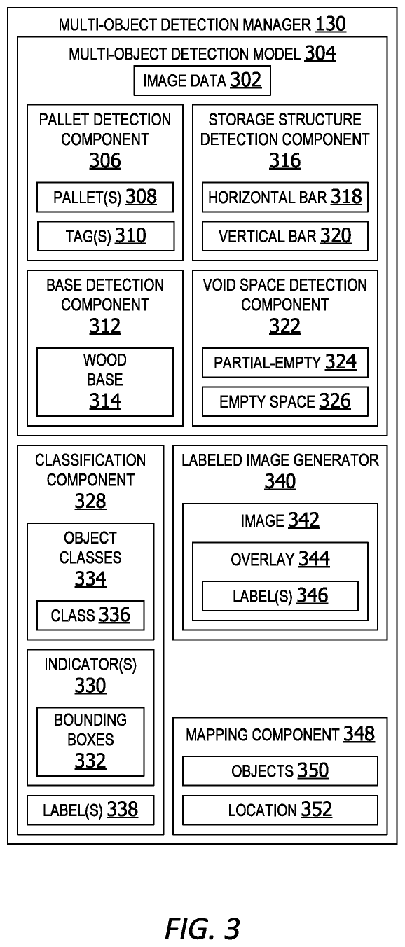

FIG. 3 is an exemplary block diagram illustrating a multi-object detection manager 130 for detecting multiple types of objects using image data 302 associated with an image of an area of interest at a recognized location. The multi-object detection model includes a multi-object detection model 304 trained to identify multiple different types of objects in images.

In some embodiments, a pallet detection component 306 includes algorithms for detecting pallet(s) 308 and pallet tag(s) 310 in the image data 302. The multi-object detection model 304 in other embodiments includes a base detection model 312. The base detection model 312 includes one or more algorithms for detecting a wood base 314 on a pallet.

A storage structure detection component 316 includes one or more algorithms for detecting and/or recognizing objects, such as, but not limited to, a horizontal bar 318 and/or a vertical bar 320. The horizontal bar and vertical bar can be composed of steel. A void space detection component 322 identifies partial-empty 324 spaces and/or empty space 326 in image data 302.

The multi-object detection manager 130 optionally includes a classification component 328 that classifies each object detected in the image data 302. The object classes 334 can include, without limitation, a pallet-related object class, a pallet storage structure-related object class, and/or an available space object class. The classification component generates indicators 330 for each class 336 and/or each type of object. Each class can include one or more types of objects. For example, the pallet-related object class can include a pallet type of object, a pallet tag type of object, and/or a pallet wood base type of object. The pallet storage structure-related object class can include a horizontal bar type of object and/or a vertical bar type of object. The available space object class can include a partial-empty type of object and/or a void (empty) type of object.

The identified objects are enclosed in bounding boxes 332 in the image data. The bounding boxes are optionally color-coded based on the class and/or type for each object. For example, horizontal bars can be enclosed in yellow bounding boxes while vertical bars are enclosed in orange bounding boxes. Thus, each type of object is assigned a different color for the bounding boxes enclosing the detected objects.

In other embodiments, the multi-object detection manager adds label(s) 338 to the image data. The one or more label(s) 338 include text, such as alphanumeric text, identifying the type of each object enclosed in a bounding box. For example, a pallet wood base can be labeled with a text label, such as, but not limited to, the word “wood” or “base.” In another example, the pallet tag objects can be labeled with a text label including the word “tag.”

Optical character recognition (OCR) is performed to read text on the detected pallet tags. The OCR detects pallet information, such as a pallet identifier (ID), item ID, and/or date a pallet tag is created. The pallet ID and/or item ID is used to retrieve data associated with the pallet and/or the items associated with each pallet tag. In one example, the system identifies a pallet ID from a pallet tag on a pallet using OCR and maps a set of items on the pallet to the location of the pallet in an item-to-location mapping table.

In some embodiments, a labeled image generator 340 generates an overlay 344 including label(s) 346 labelling the type of each object identified in the image data. The label(s) 346 are indicators included in the overlay 344. The image 342 including the overlay 344 is a labeled image.

In other embodiments, a mapping component 348 maps identified objects 350 to a recognized location 352 associated with the location of the pallet storage structure and/or the location of the image capture device generating the image data 302. The objects are mapped to the location in a database, such as, but not limited to, the database 226 in FIG. 2.

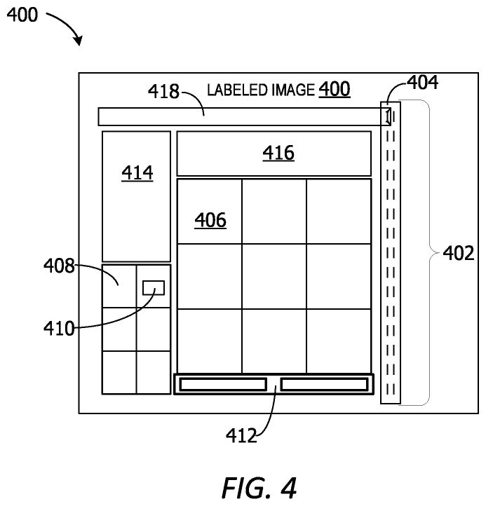

FIG. 4 is an exemplary block diagram illustrating a labeled image 400 having an overlay 402 labeling multiple different types of objects. In this example, the labeled objects include a vertical bar 404, a pallet 406, a pallet 408, a pallet tag 410 on the pallet 408, a pallet wood 412 base associated with the pallet 406, an empty 414 space, another empty 416 space, and a horizontal bar 418.

The embodiments are not limited to the labeled objects or the configuration of the labeled objects in the labeled image 400. In other embodiments, the labeled image includes more objects or fewer objects than is shown in FIG. 4.

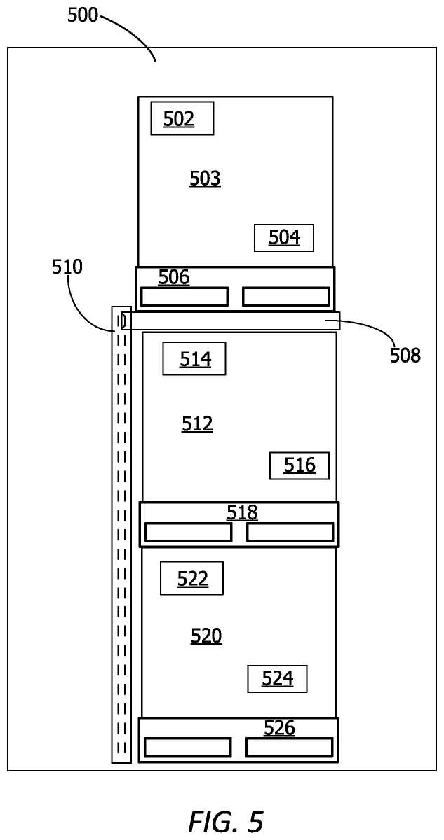

Referring now to FIG. 5, an exemplary block diagram illustrating an image overlay 500 having labels associated with recognized objects in a plurality of different object types is shown. The overlay 500 includes labels of identified objects in an image. In this example, a first pallet 503 includes a pallet 502 label in the overlay, a pallet tag 504 label, and a pallet wood 506 label in the overlay. A horizontal bar 508 label and a vertical bar label 510 are also included for pallet storage structure members associated with a pallet bin.

In this example, a second pallet 512 includes a pallet label 514, a tag label 516 and a wood 518 base label. A third pallet 520 includes a pallet label 522, a pallet tag 524 and a pallet wood 526 label for the pallet base.

The embodiments are not limited to images of areas of interest including three pallets. In other examples, the image may include no pallets, a single pallet, two pallets, as well as four or more pallets. Likewise, the embodiments are not limited to images including a single horizontal bar and a single vertical bar. In other examples, the image can include multiple horizontal bars and/or multiple vertical bars. In still other examples, there may not be any horizontal bars and/or vertical bars visible in an image.

FIG. 6 is an exemplary flow chart illustrating operation of the computing device to detect multiple objects of a plurality of different object types. The process shown in FIG. 6 is performed by a multi-object detection manager component, executing on a computing device, such as the computing device 102 in FIG. 1.

The process 600 begins by obtaining an image of an area including objects of interest at 602. The image is obtained from an image capture device, such as the image capture device(s) 116 in FIG. 1. The multi-object detection manager analyzes the image using multi-object detection model at 604. The multi-object detection model is trained using training data, such as, but not limited to, the training data 122 in FIG. 1. The multi-object detection manager identifies the objects of interest, object types and/or object classes at 606. The object types include pallets, tags, horizontal bars, vertical bars, wood bases, and empty spaces (void). The multi-object detection manager generates indicators in an image overlay identifying the object types and/or object classes at 608. The indicators include color-coded bounding boxes and/or labels/tags, such as, but not limited to, the indicators 150 in FIG. 1. The multi-object detection manager generates a labeled image at 610. The labeled image is presented to a user via a user interface (UI) at 612. The user interface is a UI, such as, but not limited to, the user interface device 110 in FIG. 1. The process terminates thereafter.

FIG. 7 is an exemplary flow chart illustrating operation of the computing device to generate a labeled image including object type indicators for objects of interest. The process shown in FIG. 7 is performed by a multi-object detection manager component, executing on a computing device, such as the computing device 102 in FIG. 1.

The process 700 begins by receiving image data associated with an image generated by an image capture device at 702. The multi-object detection manager labels objects of interest using indicators at 704. The multi-object detection manager maps the labeled objects of interest to a location within an item-to-location mapping table using the image data at 706. The image data includes the indicators identifying the type of each object. The multi-object detection manager stores the labeled image in a database at 708. The database is any type of database, such as, but not limited to, a relational database. A determination is made whether to output the labeled image at 710. If yes, the labeled image is sent to a UI for display at 712. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to recognize objects of a plurality of different types. The process shown in FIG. 8 is performed by a multi-object detection manager component, executing on a computing device, such as the computing device 102 in FIG. 1.

The process 800 begins by recognizing objects of a plurality of object types at 802. The multi-object detection manager determines if any object is of a first object type at 804. If yes, a first indicator is added to any objects of the first type at 806. The indicators are added to an overlay which is superimposed over the image of the objects. The multi-object detection manager determines if any objects are of a second type at 808. If yes, a second indicator is added to the overlay at 810. The second indicator is superimposed over all objects of the second type. A determination is made whether any of the objects are of a third type at 812. If yes, a third indicator is added to the overlay associated with the objects of the third type at 814. The process terminates thereafter.

In the example shown in FIG. 8 above, three different object types are identified, and three different indicators are used to distinguish objects from each of the three different object types. However, the embodiments are not limited to three object types. In other examples, the indicators include four or more different indicators associated with four or more different types of objects.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

### Additional Examples

In some embodiments, a multi-object detection manager is implemented on an item recognition as a service (IRAS) computer vision platform that is capable of recognizing a plurality of different types of objects, such as pallets, individual items, pallet wooden bases, pallet tags, item tags, horizontal bars, vertical bars, and void (empty) spaces.

In other embodiments, the system provides a uniform pallet layout detection model that combines five detection models into one single model, such as, but not limited to, a pallet and tag detection model, a vertical steel bar detection model, a horizontal steel bar detection model, a pallet wood detection model, and an empty space (void) detection model for pallet storage area (reserve area) combined detection.

In an example scenario, the system obtains an image of a pallet storage area. The multi-object detection model analyzes the image. The model identifies all pallets, pallet tags, pallet wooden bases, vertical steel bars, horizontal steel bars, and empty (void) spaces visible within the image. The model adds indicators to the image as an overlay. The indicators include color-coded bounding boxes surrounding the pallets, pallet tags, wood bases, vertical bars, horizontal bars, and empty spaces in the image. The model optionally also adds text labels within the overlay identifying the pallets, tags, horizontal bars, vertical bars, empty spaces, and pallet wood (wood bases) shown in the image. The system outputs a labeled image having the overlay identifying each object.

In some embodiments, the system collects images from an area of interest, such as a reserve area, from multiple stores for training the model. This ensures good representation of all objects of interest. The images are labeled with bounding boxes for each object class and/or object type using an inhouse labelling platform. The multi-object detection model is trained using the labeled training data to produce a small, lightweight, and fast multi-object detection model.

In some embodiments, the model is a pre-trained deep learning model with a convolutional neural network (CNN). In this example, the model is a you only look once (YOLO) deep learning model. The object detection model is trained on the custom labeled dataset to achieve the desired accuracy across multiple different object classes and types of objects.

In an example scenario, the system labels pallet tag empty, and partial-empty objects with rectangles. Wood, vertical bar and horizontal bar objects are labeled (annotated) with polygon bounding boxes. The polygon bounding boxes are converted to rectangles. Then the coordinates of the obtained rectangle are converted into YOLO format.

The system provides a high performance and scalable model architecture for detecting all reserved steel components. The model is smaller, faster, and more accurate than using two or more individual models to detect the different types of objects. The system uses rich datasets, including a mixture of high quality reserve steel components. The model is able to more accurately handle difficult situations, such as incorrect bounding box detections for pallet tags with different fonts, layout, and style.

In other embodiments, the multi-object detection model is a very efficient combined model that reduces the inference time by five times compared to individual models for each type of object. This enables better accuracy due to ensemble learning reduction in false positive rate by nine percent compared to individual models.

In another example scenario, a multi-object detection model is trained using labeled training data including labeled objects of interest. The system analyzes a selected image from the plurality of images of the pallet reserve area using the trained multi-object detection model. A plurality of objects of interest is identified within the selected image, by the trained multi-object detection model. The object of interest includes a pallet, pallet tag, pallet wooden base, vertical bar, horizontal bar and/or a void space. Each object of interest is labeled within the selected image. The system generates a labeled image that includes the identified objects and labels associated with the identified objects.

Alternatively, or in addition to the other examples described herein, examples include any combination of the following:
an image capture device capturing an image of a plurality of objects of interest associated with a plurality of object types at a recognized location within a retail facility;
a computer-readable medium storing instructions that are operative upon execution by the processor to analyze the image using a multi-object detection model identifying the plurality of objects of interest within the image;
identify the plurality of objects of interest associated with the plurality of object types within the image;
the plurality of objects of interest comprising a first object associated with a first object type and a second object associated with a second object type;
generate a labeled image of the recognized area, the labeled image comprising a plurality of indicators within an overlay associated with the selected image;
the plurality of indicators comprising a first indicator associated with the first object of interest within the image and a second indicator associated with the second object of interest within the image, wherein the labeled image is presented to a user via a user interface device;
train a multi-object detection model using labeled training data comprising labeled objects of interest associated with the plurality of object types;
wherein the plurality of indicators comprises a pallet indicator, a tag indicator, a wooden base indicator, a vertical bar indicator, a horizontal bar indicator, and a void space indicator;
generate a plurality of color-coded bounding boxes associated with the plurality of objects of interest, wherein all objects of a same object type within the image are enclosed within a bounding box of a same color;
enclosing a first set of objects from the plurality of objects of interest within a first set of bounding boxes of a first color, the first set of bounding boxes associated with a first object type;
enclosing a second set of objects from the plurality of objects of interest within a second set of bounding boxes of a second color, the second set of bounding boxes associated with a second object type;
enclosing a third set of objects from the plurality of objects of interest within a third set of bounding boxes of a third color, the third set of bounding boxes associated with a third object type;
enclosing a fourth set of objects from the plurality of objects of interest within a fourth set of bounding boxes of a fourth color, the fourth set of bounding boxes associated with a fourth object type;
enclosing a fifth set of objects from the plurality of objects of interest within a fifth set of bounding boxes of a fifth color, the fifth set of bounding boxes associated with a fifth object type;
map the plurality of objects associated with the plurality of object types to the recognized location in an item-to-location mapping table using labeled image data associated with the labeled image;
obtaining an image of a recognized area associated with a retail facility, the image comprising a plurality of objects of interest associated with a plurality of object types;
analyzing the image by a multi-object detection model, the multi-object detection model trained to recognize the plurality of object types using image data;
identifying the plurality of objects of interest associated with the plurality of object types within the image and an object type for each identified object;
generating a plurality of indicators within the image data associated with the plurality of objects of interest, the plurality of indicators comprising a first indicator of a first object type associated with a first object of a first object type and a second indicator of a second object type associated with a second object of a second object type in the plurality of object types, wherein the second indicator is a different indicator than the first indicator;
generating a labeled image of the recognized area, the labeled image comprising the plurality of indicators within an overlay associated with the selected image;
identifying a pallet identifier (ID) from the pallet tag using optical character recognition; and
mapping a set of items on the pallet to the recognized location in the item-to-location mapping table using the pallet ID;
presenting the labeled image to a user via a user interface device;
training the multi-object detection model to recognize the plurality of types of objects using labeled training data comprising labeled objects of interest associated with the plurality of object types;
wherein the plurality of types of objects comprises pallets, pallet tags, pallet wooden bases, pallet steel vertical bars, pallet steel horizontal bars, pallet void spaces, and pallet partial-empty spaces;
generating a first bounding box of a first color enclosing each instance of the first type of object in the image;
generating a second bounding of a second color enclosing each instance of the second type of object in the image;
generating a plurality of labels within the overlay corresponding to the plurality of objects of interest, the plurality of labels comprising a first label associated with each instances of the first type of object within the image and a second label associated with each instance of the second type of object within the image, wherein the first label comprises text identifying the first type of object, and wherein the second label comprises text identifying the second type of object;
enclosing each pallet object and each pallet tag object with a rectangular bounding box enclosing each pallet object within the image;
enclosing each pallet wooden base object, each pallet steel vertical bar object, and each pallet steel horizontal bar object with a polygon bounding box during image analysis, wherein each bounding box associated with each different type of object is a different color;
mapping the plurality of objects associated with the plurality of object types to the recognized location in an item-to-location mapping table using the image data associated with the labeled image;
training the multi-object detection model using a labeled training data set comprising a first set of labeled training images including labeled instances of the first type of object and a second set of labeled training images including labeled instances of the second type of object;
identifying a pallet within the image by the multi-object detection model; identifying a pallet tag on the pallet within the image by the multi-object detection model; identifying a set of items on the pallet based on information obtained from the pallet tag using optical character recognition (OCR); and mapping the set of items on the pallet to the recognized location in the item-to-location mapping table;
identifying a pallet within the image by the multi-object detection model; identifying a pallet steel vertical bar and a pallet steel horizontal bar by the multi-object detection model; identifying a pallet bin location using the pallet steel vertical bar and the pallet steel horizontal bar by the multi-object detection model; and mapping a set of items associated with the pallet to the pallet bin location in the item-to-location mapping table;
identifying a set of pallets within the recognized location by the multi-object detection model; identifying a set of pallet void spaces within the recognized location by the multi-object detection model, the set of void spaces comprising a set of pallet void spaces and a set of partial-empty spaces; and assigning newly arriving pallets to the set of pallet void spaces, wherein the newly arriving pallets are placed into available spaces in the set of pallet void spaces for temporary storage; and
generating a plurality of color-coded labels corresponding to the plurality of objects of interests, wherein a label of a first color is associated with each instance of an object of a first type within the labeled image data, and wherein a label of a second color is associated with each instance of an object of the second type within the labeled image data.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 6, FIG. 7, and FIG. 8 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of multi-object detection using computer vision, the method comprising obtaining an image of a recognized area associated with a retail facility, the image comprising a plurality of objects of interest associated with a plurality of object types; analyzing the image by a multi-object detection model, the multi-object detection model trained to recognize the plurality of object types using image data; identifying the plurality of objects of interest associated with the plurality of object types within the image and an object type for each identified object; generating a plurality of indicators within the image data associated with the plurality of objects of interest, the plurality of indicators comprising a first indicator of a first object type associated with a first object of a first object type and a second indicator of a second object type associated with a second object of a second object type in the plurality of object types, wherein the second indicator is a different indicator than the first indicator; generating a labeled image of the recognized area, the labeled image comprising the plurality of indicators within an overlay associated with the selected image; and presenting the labeled image to a user via a user interface device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for multi-object detection via a unified model. For example, the elements illustrated in FIG. 1, FIG. 2, and FIG. 3, such as when encoded to perform the operations illustrated in FIG. 6, FIG. 7, and FIG. 8, constitute exemplary means for training a multi-object detection model using labeled training data comprising labeled objects of interest associated with the plurality of object types; exemplary means for analyzing a selected image from the plurality of images using a multi-object detection model identifying the plurality of objects of interest within the image; exemplary means for identifying the plurality of objects of interest associated with the plurality of object types within the image, the plurality of objects of interest comprising a first object associated with a first object type and a second object associated with a second object type; exemplary means for generating labeled image data based on the image, the labeled image data comprising a plurality of indicators associated with the selected image, the plurality of indicators comprising a first indicator associated with the first object of interest within the image and a second indicator associated with the second object of interest within the image; and exemplary means for mapping the plurality of objects to the recognized location using the labeled image data, wherein the plurality of objects are mapped to the recognized location in an item-to-location mapping table.

Other non-limiting examples provide one or more computer storage devices having a first computer-executable instructions stored thereon for providing multi-object detection via a unified model. When executed by a computer, the computer performs operations including analyze the image using a multi-object detection model identifying the plurality of objects of interest within the image; identify the plurality of objects of interest associated with the plurality of object types within the image, the plurality of objects of interest comprising a first object associated with a first object type and a second object associated with a second object type; and generate a labeled image of the recognized area, the labeled image comprising a plurality of indicators within an overlay associated with the selected image, the plurality of indicators comprising a first indicator associated with the first object of interest within the image and a second indicator associated with the second object of interest within the image, wherein the labeled image is presented to a user via a user interface device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multi-object detection with improved accuracy, the system comprising:
an image capture device capturing an image of a plurality of objects of interest associated with a plurality of object types at a recognized location within a retail facility; and
a computer-readable medium storing instructions that are operative upon execution by a processor to:
analyze the image using a multi-object detection model identifying the plurality of objects of interest within the image;
identify the plurality of objects of interest associated with the plurality of object types within the image, the plurality of objects of interest comprising a first object associated with a first object type and a second object associated with a second object type; and
generate a labeled image of an area, the labeled image comprising a plurality of indicators within an overlay associated with the image, the plurality of indicators comprising a first indicator associated with the first object of interest within the image and a second indicator associated with the second object of interest within the image, wherein the labeled image is presented to a user via a user interface device.

2. The system of claim 1, wherein the instructions are further operative to:
train the multi-object detection model using labeled training data comprising labeled objects of interest associated with the plurality of object types.

3. The system of claim 1, wherein the plurality of indicators comprises a pallet indicator, a tag indicator, a wooden base indicator, a vertical bar indicator, a horizontal bar indicator, and a void space indicator.

4. The system of claim 1, wherein the instructions are further operative to:
generate a plurality of color-coded bounding boxes associated with the plurality of objects of interest, wherein all objects of a same object type within the image are enclosed within a bounding box of a same color.

5. The system of claim 1, wherein the instructions are further operative to:
enclosing a first set of objects from the plurality of objects of interest within a first set of bounding boxes of a first color, the first set of bounding boxes associated with a first object type;
enclosing a second set of objects from the plurality of objects of interest within a second set of bounding boxes of a second color, the second set of bounding boxes associated with a second object type; and
enclosing a third set of objects from the plurality of objects of interest within a third set of bounding boxes of a third color, the third set of bounding boxes associated with a third object type.

6. The system of claim 5, wherein the instructions are further operative to:
enclosing a fourth set of objects from the plurality of objects of interest within a fourth set of bounding boxes of a fourth color, the fourth set of bounding boxes associated with a fourth object type; and
enclosing a fifth set of objects from the plurality of objects of interest within a fifth set of bounding boxes of a fifth color, the fifth set of bounding boxes associated with a fifth object type.

7. The system of claim 1, wherein the instructions are further operative to:
map the plurality of objects associated with the plurality of object types to the recognized location in an item-to-location mapping table using labeled image data associated with the labeled image.

8. A method for multi-object detection, the method comprising:
obtaining an image of a recognized area associated with a retail facility, the image comprising a plurality of objects of interest associated with a plurality of object types;
analyzing the image by a multi-object detection model, the multi-object detection model trained to recognize the plurality of object types using image data;
identifying the plurality of objects of interest associated with the plurality of object types within the image and an object type for each identified object;
generating a plurality of indicators within the image data associated with the plurality of objects of interest, the plurality of indicators comprising a first indicator of a first object type associated with a first object of a first object type and a second indicator of a second object type associated with a second object of a second object type in the plurality of object types, wherein the second indicator is a different indicator than the first indicator;
generating a labeled image of the recognized area, the labeled image comprising the plurality of indicators within an overlay associated with the image; and
presenting the labeled image to a user via a user interface device.

9. The method of claim 8, further comprising:
training the multi-object detection model to recognize the plurality of object types using labeled training data comprising labeled objects of interest associated with the plurality of object types.

10. The method of claim 9, wherein the plurality of object types comprises pallets, pallet tags, pallet wooden bases, pallet steel vertical bars, pallet steel horizontal bars, pallet void spaces, and pallet partial-empty spaces.

11. The method of claim 8, further comprising:
generating a first bounding box of a first color enclosing each instance of a first type of object in the image; and
generating a second bounding of a second color enclosing each instance of a second type of object in the image.

12. The method of claim 8, further comprising:
generating a plurality of labels within the overlay corresponding to the plurality of objects of interest, the plurality of labels comprising a first label associated with each instances of a first type of object within the image and a second label associated with each instance of a second type of object within the image, wherein the first label comprises text identifying the first type of object, and wherein the second label comprises text identifying the second type of object.

13. The method of claim 8, further comprising:
enclosing each pallet object and each pallet tag object with a rectangular bounding box enclosing each pallet object within the image; and
enclosing each pallet wooden base object, each pallet steel vertical bar object, and each pallet steel horizontal bar object with a polygon bounding box during image analysis, wherein each bounding box associated with each different type of object is a different color.

14. The method of claim 8, further comprising:
mapping the plurality of objects associated with the plurality of object types to a recognized location in an item-to-location mapping table using the image data associated with the labeled image.

15. One or more computer storage devices having computer-executable instructions stored thereon, which, upon execution by a computer, cause the computer to perform operations comprising:
training a multi-object detection model using labeled training data comprising labeled objects of interest associated with a plurality of object types;
analyzing an image from a plurality of images using a multi-object detection model identifying a plurality of objects of interest within the image;
identifying the plurality of objects of interest associated with the plurality of object types within the image, the plurality of objects of interest comprising a first object associated with a first object type and a second object associated with a second object type;
generating labeled image data based on the image, the labeled image data comprising a plurality of indicators associated with the image, the plurality of indicators comprising a first indicator associated with the first object of interest within the image and a second indicator associated with the second object of interest within the image; and
mapping the plurality of objects to a recognized location using the labeled image data, wherein the plurality of objects is mapped to the recognized location in an item-to-location mapping table.

16. The one or more computer storage devices of claim 15, wherein the operations further comprise:
training the multi-object detection model using a labeled training data set comprising a first set of labeled training images including labeled instances of a first type of object and a second set of labeled training images including labeled instances of a second type of object.

17. The one or more computer storage devices of claim 15, wherein the operations further comprise:
identifying a pallet within the image by the multi-object detection model;
identifying a pallet tag on the pallet within the image by the multi-object detection model;
identifying a pallet identifier (ID) from the pallet tag using optical character recognition; and
mapping a set of items on the pallet to the recognized location in the item-to-location mapping table using the pallet ID.

18. The one or more computer storage devices of claim 15, wherein the operations further comprise:
identifying a pallet within the image by the multi-object detection model;
identifying a pallet steel vertical bar and a pallet steel horizontal bar by the multi-object detection model;
identifying a pallet bin location using the pallet steel vertical bar and the pallet steel horizontal bar by the multi-object detection model; and
mapping a set of items associated with the pallet to the pallet bin location in the item-to-location mapping table.

19. The one or more computer storage devices of claim 15, wherein the operations further comprise:
identifying a set of pallets within the recognized location by the multi-object detection model;
identifying a set of pallet void spaces within the recognized location by the multi-object detection model; and
assigning newly arriving pallets to the set of pallet void spaces, wherein the newly arriving pallets are placed into available spaces in the set of pallet void spaces for temporary storage.

20. The one or more computer storage devices of claim 15, wherein the operations further comprise:
generating a plurality of color-coded labels corresponding to the plurality of objects of interests, wherein a label of a first color is associated with each instance of an object of a first type within the labeled image data, and wherein a label of a second color is associated with each instance of an object of a second type within the labeled image data.
